(19) United States
(12) Patent Application Publication
(10) Pub. No.: US 2013/0148815 A1
(43) Pub. Date: Jun. 13, 2013

(54) NOISE TESTING SYSTEM AND METHOD

(71) Applicants: Xiao-Li LIU, Wuhan City (CN); Yu-Lin LIU, Wuhan City (CN); Wen-Ming YI, Wuhan City (CN); Cong-Xu HU, Wuhan City (CN)

(72) Inventors: Xiao-Li LIU, Wuhan City (CN); Yu-Lin LIU, Wuhan City (CN); Wen-Ming YI, Wuhan City (CN); Cong-Xu HU, Wuhan City (CN)

(73) Assignees: HON HAI PRECISION INDUSTRY CO., LTD., Tu-Cheng (TW); HONG FU JIN PRECISION INDUSTRY (WuHan) CO., LTD., Wuhan City (CN)

(21) Appl. No.: 13/550,677

(22) Filed: Jul. 17, 2012

(30) Foreign Application Priority Data
Dec. 13, 2011 (CN) 201110414520.3

(51) Int. Cl. H04R 29/00

(52) U.S. Cl. 381/56

(57) ABSTRACT

A noise testing system includes an electronic device, a noise meter and a testing desk. The electronic device includes a plurality of separated electronic components. The noise meter is used to test a noise generated by the electronic device. The testing desk includes a surface. A plurality of scale markings is defined in the surface, and a plurality of scale value is labeled on the surface and correspond to the plurality of scale marking. A first distance between every two of the plurality of separated electronic components and a second distance between the noise meter and each of the plurality of separated electronic components is adjusted to be in a fixed range according to the plurality of scale marking. A noise testing method based upon the above noise testing system is further disclosed.

### BACKGROUND

1. Technical Field

The present disclosure relates to a noise testing system and a noise testing method.

2. Description of Related Art

When testing noise generated by an electronic device, the electronic device is placed on a fixed location, and a noise meter is adjacent to the electronic device. The noise meter can detect the noise level generated by the electronic device. If the noise level generated by the electronic device is greater than a predetermined noise level, the noise of the electronic device is ineligible. However, it is very inconvenient to manually measure a test distance between the noise meter and the electronic device. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a view of a noise testing system in accordance with an embodiment.

FIG. 2 is an isometric view of the noise testing system of FIG. 1.

FIG. 3 is a front view of a surface of a desk of FIG. 2.

FIG. 4 is a diagram of a noise testing method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

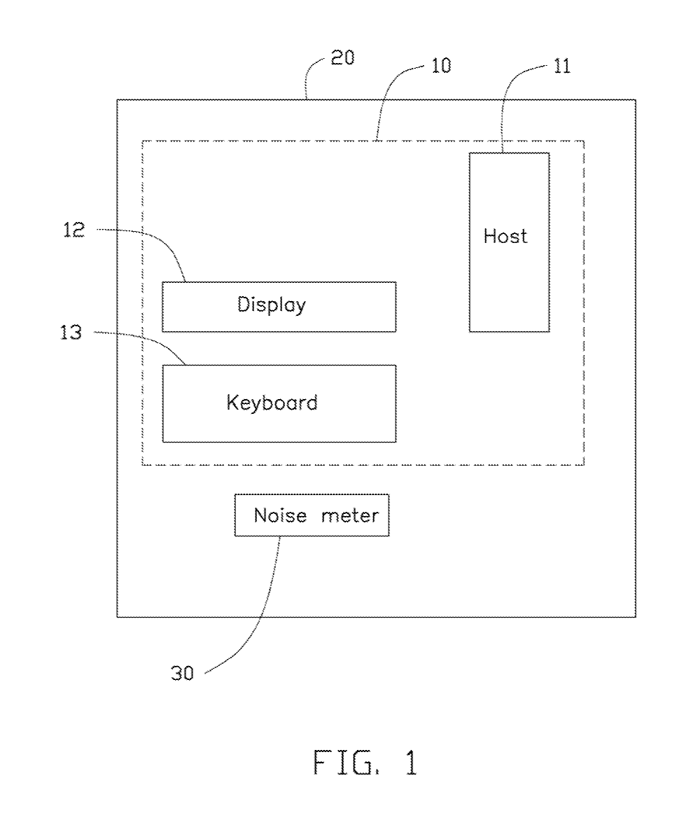

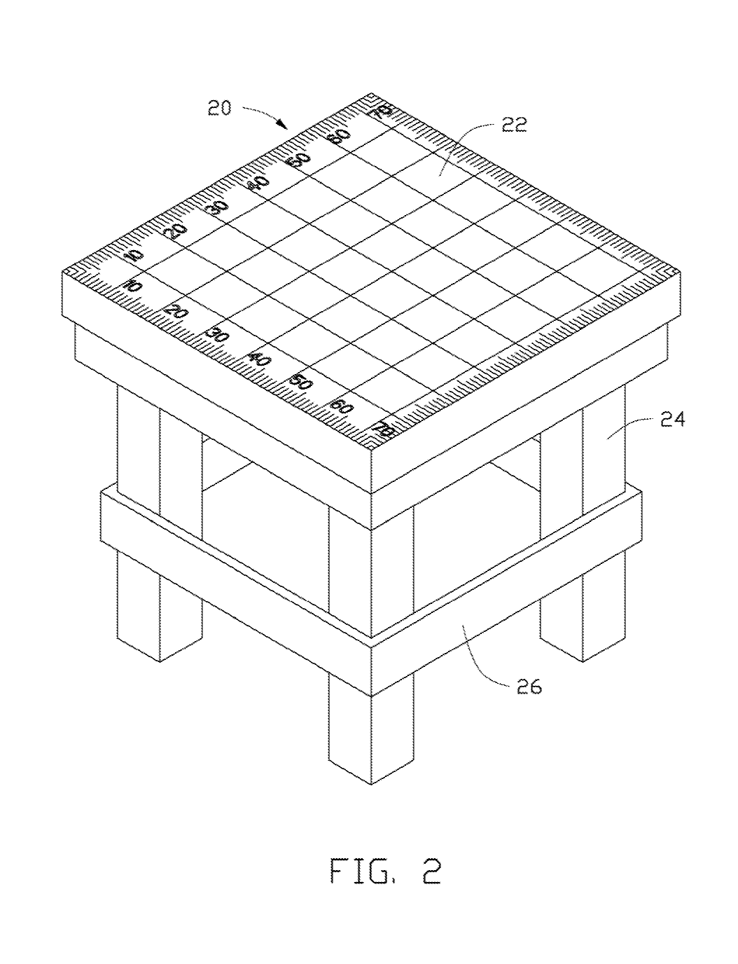

FIGS. 1 and 2, illustrate a noise testing system in accordance with an embodiment. The noise level testing system includes a computer 10, a testing desk 20, and a noise meter 30. The computer 10 includes a host 11, a display 12 and a keyboard 13.

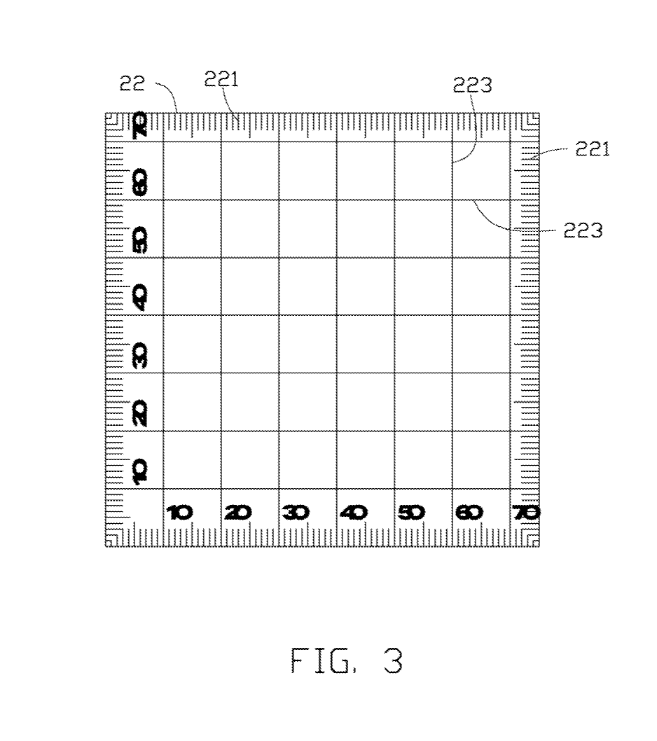

FIGS. 2-3, illustrate the testing desk 20 of the embodiment. The testing desk 20 includes a surface 22, four feet 22 substantially perpendicularly extending from the surface 22, and four strengthening ribs 26 surrounding the four feet 22. Each of the four strengthening ribs 26 is substantially perpendicular to the feet 24 and located between two of the four feet 24. In one embodiment, the surface 22 is a rectangle or a square. A plurality of scale marks 221 and a plurality of gridlines 23 connected to the plurality of scale markings 221. The plurality of scale markings 221 are arranged at four edges of the surface 22. In one embodiment, a distance between every adjacent two of the plurality of scale markings 221 is 1 cm. The plurality of gridlines 23 includes a plurality of parallel horizontal lines and a plurality of parallel longitudinal lines substantially perpendicular to the plurality of parallel horizontal lines. The minimum scale value of the plurality of parallel horizontal lines and the longitudinal lines maybe 10 cm, a plurality of scale values, such as 10, 20, 30, 40, 50, 60, 70, are labeled at least two adjacent edges of the four edges of the surface 22. The plurality of parallel horizontal lines and the plurality of parallel longitudinal lines are connected to the scale markings which has labeled with the plurality of scale values.

In testing, the host 11, the display 12, and the keyboard 13 are placed on the surface 22 and located in a predetermined location by the plurality of scale markings 221 and the plurality of gridlines 223. The noise meter 30 is placed on the surface 20, and a distance, between the noise meter 30 and the computer 10 including the host 11, the display 12, and the keyboard 13, is a predetermined distance by the plurality of scale markings 221 and the plurality of grid lines 223. When the computer 10 is powered, the host 11, the display 12 and the keyboard 13 starts to work, and the noise meter 30 can test the noise generated by the host 11, the display 12 and the keyboard 13. In one embodiment, the noise meter 30 includes a screen to display the noise level in decibels of the host 11, the display 12 and the keyboard 13. The decibels can be compared with a predetermined decibel, to determine whether the noise level of the computer 10 is eligible.

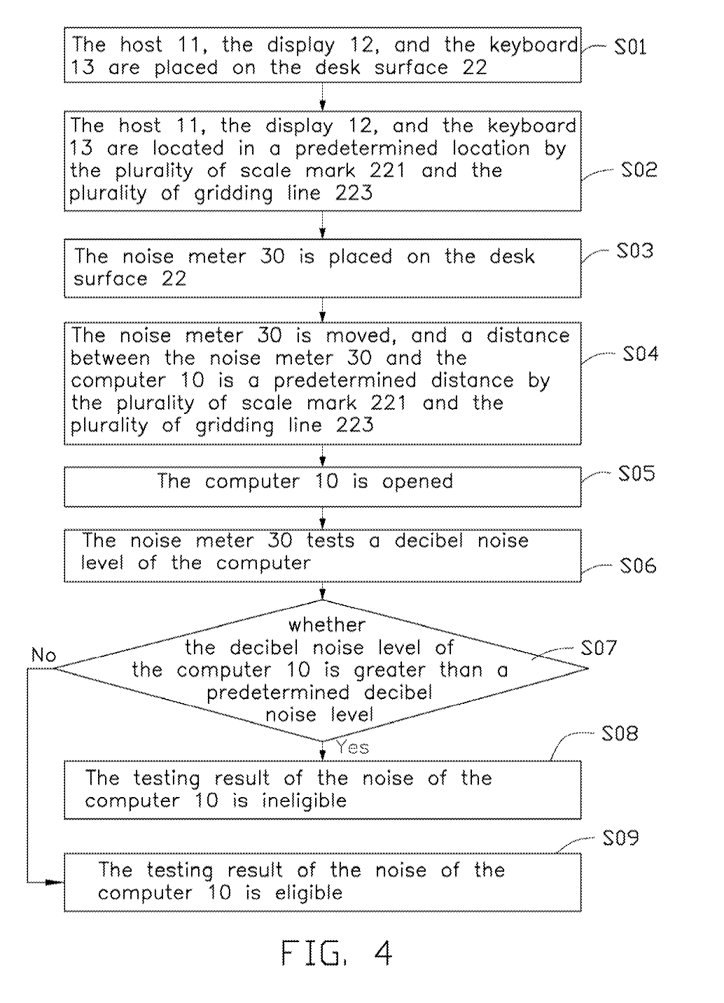

FIG. 4, illustrates a noise testing method in accordance with an embodiment. The noise testing method includes the following steps:

Step 01: the host 11, the display 12, and the keyboard 13 are placed on the surface 22.

Step 02: The host 11, the display 12, and the keyboard 13 are located in a predetermined location by the plurality of scale markings 221 and the plurality of gridlines 223. In one embodiment, the host 11 is aligned with the plurality of scale markings 221 and the plurality of gridlines 223, and then the display 12 and the keyboard 13 are placed on the predetermined location.

Step 03: the noise meter 30 is placed on the surface 22.

Step 04: the noise meter 30 is moved, and distances between the noise meter 30 and the host 11, the display 12, and the keyboard 13, are all adjusted to a predetermined range by observing the plurality of scale markings 221 and the plurality of gridlines 223.

Step 05: The computer 10 is powered on, the host 11, the display 12 and the keyboard 13 starts to work, and the noise meter 30 can test the noise generated by the host 11, the display 12 and the keyboard 13.

Step 06: The host 11, the display 12 and the keyboard 13 generate noise.

Step 07: The noise meter 30 tests a noise level of the host 11 in decibels, the display 12 and the keyboard 13, and the noise level can be compared with a predetermined noise level. If the noise level of the computer 10 is greater than the predetermined noise level, the Step 08 is followed. If the noise level of the computer 10 is less than the predetermined noise level, the Step 09 is followed.

Step 08: The testing result of the noise of the computer 10 is ineligible.

Step 09: The testing result of the noise of the computer 10 is eligible.

In one embodiment, the host 11, the display 12 and the keyboard 13 can be separately tested the noise by the noise testing system. The noise testing system can be used to test the noise of a notebook, a PDA, a phone, or a printer, for example.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A noise testing system comprising:
a testing desk comprising a surface; a plurality of scale markings defined in the surface, and the plurality of scale markings being configured to label a distance between every two points on the surface;
an electronic device comprising a plurality of electronic components located on the testing desk; and
a noise meter located on the testing desk, and the noise meter being configured for testing a noise generated by the electronic device;
wherein a plurality of distances between the noise meter and the plurality of electronic components are within a determined range.

2. The noise testing system of claim 1, wherein the electronic device is a desk computer, and the plurality of separated electronic components comprises a host, a display and a keyboard.

3. The noise testing system of claim 1, wherein the testing desk further comprises four desk feet extending from the surface and four strengthening ribs being substantially perpendicularly connected to each of the four desk feet, and the four strengthening ribs surrounds the desk four feet.

4. The noise testing system of claim 1, wherein the surface is a rectangle or a square, the plurality of scale markings are arranged at the four edges of the surface, and the plurality of scale markings are labeled at least two adjacent edges of the four edges of the surface.

5. The noise testing system of claim 4, wherein a plurality of grid lines is defined in the surface, and the plurality of grid lines includes a plurality of parallel horizontal lines and a plurality of parallel longitudinal lines substantially perpendicular to the plurality of parallel horizontal lines.

6. The noise testing system of claim 5, wherein the plurality of parallel horizontal lines and the plurality of parallel longitudinal lines are connected to the scale markings which is labeled with the plurality of scale values.

7. The noise testing system of claim 6, wherein a distance between every adjacent two of the plurality of scale markings is 1 centimeter, a distance of every adjacent two of the plurality of parallel horizontal lines is 10 centimeter, and a distance of every adjacent two of the plurality of parallel longitudinal lines is also 10 centimeter.

8. A noise testing method comprising:
providing a testing desk, and the testing desk comprising a plurality of scale markings;
placing an electronic device and a noise meter on the testing desk;
adjusting a distance between the electronic device and the noise meter to a determined range according to the plurality of scale markings; testing a noise level generated by the electronic device; and
judging whether the noise level is greater than a predetermined noise level.

9. The noise testing method of claim 8, comprising adjusting a first distance between every two of the plurality of separated electronic components and a second distance between the noise meter and each of the plurality of separated electronic components to be in a fixed range according to the plurality of scale marking.

10. The noise testing method of claim 8, further comprising comparing the noise level with the predetermined noise level, before judging whether the noise level is greater than a predetermined noise level.

11. The noise testing method of claim 8, wherein if the noise level is greater than the predetermined noise level, the testing result is ineligible, and if the noise level is less than the predetermined noise level, the testing result is ineligible.

12. The noise testing method of claim 8, wherein the electronic device is a desk computer, and the plurality of separated electronic components comprises a host, a display and a keyboard.

13. The noise testing method of claim 8, wherein a distance between every adjacent two of the plurality of scale markings is 1 centimeter, a distance of every adjacent two of the plurality of parallel horizontal lines is 10 centimeter, and a distance of every adjacent two of the plurality of parallel longitudinal lines is also 10 centimeter.

14. The noise testing method of claim 8, wherein the testing desk further comprises a plurality of grid line, and the plurality of grid lines includes a plurality of parallel horizontal lines and a plurality of parallel longitudinal lines substantially perpendicular to the plurality of parallel horizontal lines.
